(19) United States
(12) Patent Application Publication
(10) Pub. No.: US 2024/0109144 A1
(43) Pub. Date: Apr. 4, 2024

(54) Laser-Assisted Soldering Apparatus

(71) Applicant: Pac Tech - Packaging Technologies GmbH, Nauen (DE)

(72) Inventors: Matthias Fettke, Berlin (DE); Andrej Kolbasow, Paulinenaue (DE); Jan Hoffmann, Michendorf (DE)

(21) Appl. No.: 18/375,525

(22) Filed: Oct. 1, 2023

(30) Foreign Application Priority Data
Oct. 4, 2022 (LU) 103023

(51) Int. Cl. B23K 1/005; B23K 3/06; B23K 3/08

(52) U.S. Cl. CPC B23K 1/0056; B23K 3/0623; B23K 3/082

(57) ABSTRACT

A soldering apparatus includes an application device, a conveying device and an application nozzle. The application device has a laser duct extending straight from a laser entry at the top to a laser exit at the bottom and a drop duct that extends from a drop entry at the top to a drop exit at the bottom of the application device. The conveying device separately conveys solder bodies to the drop entry. The application nozzle temporarily holds solder bodies received from the drop exit. The laser and drop ducts are interconnected over their entire lengths from the top to the bottom of the application device. The drop entry and laser entry are side by side and form a common entry. The drop exit and laser exit are spatially coincident and form a common exit that is smaller than the common entry. The application nozzle is connected to the common exit.

### CROSS REFERENCE TO RELATED APPLICATION

This application is based on and hereby claims the benefit under 35 U.S.C. § 119 from Luxembourg Patent Application No. LU103023, filed on Oct. 4, 2022, in the Luxembourg Intellectual Property Office. This application is a continuation-in-part of Luxembourg Patent Application No. LU103023, the contents of which are incorporated herein by reference.

### TECHNICAL FIELD

The present invention relates to a laser-assisted soldering apparatus for the separate application of solder bodies, in particular solder balls, to a workpiece.

### BACKGROUND

A device for the separate application of connecting material deposits is known from U.S. Pat. No. 10,286,470 B2. The device comprises an application device and an application nozzle through which the connecting material deposits are applied. In the application device there is formed an application duct which extends straight through the lower housing part and through which a laser is applied to the connecting material deposit held in the application nozzle. Further, a supply duct through which a connecting material deposit is conveyed to the application nozzle is separately formed from the application duct in an oblique manner in the application device. Hence, the above device includes the drawback that the supply duct is difficult to form in the lower housing part and that a size or diameter of the connecting material deposit is limited to a diameter of the supply duct.

Therefore, it is the object of the present invention to overcome the drawbacks of the prior art and to provide an improved and flexible laser-assisted soldering apparatus for the separate application of solder bodies. It is a further object of the present invention to provide a laser-assisted soldering apparatus that can be easily manufactured and can be flexibly adapted to multiple applications, such as the application of solder bodies having a larger diameter.

### SUMMARY

A laser-assisted soldering apparatus for the separate application of solder bodies comprises an application device having a laser duct extending from a laser entry to a laser exit and a drop duct extending from a drop entry to a drop exit, and a conveying device configured to separately convey solder bodies to the drop entry. The laser duct and the drop duct are formed so as to be interconnected over their full lengths. The drop entry and the laser entry are arranged side by side so as to form a common entry opening. The drop exit and the laser exit are spatially coincident so as to form a common exit opening smaller than the common entry opening. An application nozzle is connected to the common exit opening

A laser-assisted soldering apparatus for separately applying solder bodies includes an application device, a conveying device, an application nozzle, an application nozzle holder, a laser shield, and a housing. The application device has a laser duct that extends along a straight line from a laser entry at the top of the application device to a laser exit at the bottom of the application device. A drop duct extends from a drop entry at the top of the application device to a drop exit at the bottom of the application device. The conveying device separately conveys the solder bodies to the drop entry. The application nozzle is disposed at the bottom of the application device and is adapted to temporarily hold a solder body received from the drop exit. The laser duct and the drop duct are formed so as to be interconnected over their entire lengths from the top of the application device to the bottom of the application device. The drop entry and the laser entry are arranged side by side so as to form a common entry opening. The drop exit and the laser exit are spatially coincident so as to form a common exit opening that is smaller than the common entry opening. The application nozzle is connected to the common exit opening. The application nozzle holder is detachably connected to the bottom of the application device and holds the application nozzle. The laser shield encloses the application nozzle and surrounds a spot that is to be soldered.

The housing includes an upper housing part and a lower housing part. The application device that has the laser duct and the drop duct is integrated into the lower housing part. The conveying device is disposed between the upper housing part and the lower housing part. A guide duct is formed in the upper housing part through which the solder bodies are guided to the conveying device. The conveying device is adapted to transfer the solder bodies from the guide duct to the drop entry and includes a transport element with receiving holes configured to receive the solder bodies and to transport the solder bodies from the guide duct to the drop entry.

A laser-assisted soldering apparatus also includes an optical sensor, a controller and a laser source. The optical sensor is adapted to detect whether solder bodies are present in the receiving holes. The controller adjusts the movement of the conveying device based on whether the optical sensor detects that no solder body is present in a receiving hole. The laser source emits a laser beam that passes through the laser duct. The controller also controls the laser source to emit the laser beam in a pulse modulated manner.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 shows an exploded view of a laser-assisted soldering apparatus.

FIG. 2 shows a cross-section view of the laser-assisted soldering apparatus.

FIG. 3 shows a top view of the laser-assisted soldering apparatus.

FIG. 4 shows the laser-assisted soldering apparatus comprising a solder body reservoir.

FIG. 5 shows a top view of the laser-assisted soldering apparatus comprising the solder body reservoir.

FIG. 6 shows a bottom view of the laser assisting soldering apparatus comprising an application nozzle holder and an application nozzle.

FIG. 7 shows the laser-assisted soldering apparatus and different application nozzle holders.

FIG. 8 shows an application nozzle holder to which a laser shield is mounted.

FIG. 9 shows a cross-section view of the application nozzle holder to which the laser shield is mounted.

FIG. 10 shows a time diagram representing a laser pulse modulation pattern.

FIG. 11 shows a schematic view of a flux dispenser for dispensing flux to a solder body exiting the application nozzle.

### DETAILED DESCRIPTION

Reference will now be made in detail to some embodiments of the invention, an example of which is illustrated in the accompanying drawing.

A laser-assisted soldering apparatus for the separate application of solder bodies, in particular solder balls, to a workpiece, according to the present invention comprises an application device having a laser duct extending along a straight line from a laser entry at a top of the application device to a laser exit at a bottom of the application device, and a drop duct extending from a drop entry at the top of the application device to a drop exit at the bottom of the application device. The apparatus further comprises a conveying device configured to separately convey solder bodies to the drop entry, and an application nozzle provided at the bottom of the application device and configured to temporarily hold a solder body exiting the drop exit.

The laser duct and the drop duct are formed so as to be interconnected over their full lengths from the top to the bottom of the application device. In this respect, interconnected means that the laser duct and the drop duct are not separated by side walls or other means and that the both ducts are formed so as to obtain a single passage in the laser-assisted soldering apparatus. The drop entry and the laser entry are arranged side by side so as to form a common entry opening and the drop exit and the laser exit are spatially coincident so as to form a common exit opening smaller than the common entry opening. In other words, the laser duct and the drop duct are formed so that their cross-sections overlap each other along their extensions from the top to the bottom of the application device to form the common entry opening at the top and the common exit opening at the bottom of the application device. That is, a degree of over-lapping of the cross-sections of the laser duct and the drop duct increases from a partial overlap at the top to a full overlap at the bottom of the application device. Further, the application nozzle is connected to the common exit opening.

According to an aspect of the present invention the drop entry and the laser entry form a common non-circular entry opening and the drop exit and the laser exit form a common circular exit opening. Therefore, the common non-circular entry opening and the common circular exit opening can be simply formed by straightly drilling the laser duct and then by milling the drop duct, e.g., by using a ball cutter, so as to be interconnected with the laser duct.

Hence, the laser duct and the drop duct may be easily formed in the application device. Moreover, the diameter of the solder bodies is not limited to the diameter of the drop duct as the laser duct is also useable to transport solder bodies to the application nozzle. As a result, solder bodies with a large diameter can be applied by using the laser-assisted soldering apparatus according to the present invention.

In particular, the solder body is held at a tip of the application nozzle having a diameter smaller than a diameter of the solder body. For this reason the application nozzle tapers from the common exit opening towards its tip. When the solder body is held at the tip and closes an opening of the application nozzle, pressure gas, in particular inert gas, from a pressure gas source, in particular from an inert gas source, is introduced into the application nozzle. Afterwards, a laser beam is applied to the solder body in order to liquefy or melt the same. When the solder body held at the tip of the application nozzle is sufficiently liquefied or melted, it is jetted out of the application nozzle towards the workpiece.

Alternatively, an opening of the application nozzle may be substantially the same or slightly larger than the diameter of the solder body so that the solder body can exit the application nozzle. The solder body can then be held at the tip of the application nozzle in that the application nozzle is distanced from the workpiece less than a diameter of the solder body. Hence, the solder body is held between the application nozzle and the work piece. Afterwards, the laser beam is applied to the solder body in order to melt or liquefy it such that a solder joint is obtained on the workpiece. Then the application nozzle is moved away from the workpiece.

According to an aspect of the invention the solder bodies may have a diameter between 0.9 μm and 2 mm. In particular, the solder bodies may be solder balls which are substantially round. In the present specification, solder bodies having a diameter in the above range are referred to as large solder bodies or solder bodies with a large diameter. Hence, the laser-assisted soldering apparatus may be used for applications which require a large amount of solder to form a strong and durable solder connection.

According to an aspect of the invention the drop duct may extend along a curved line from the top to the bottom of the application device. Hence, the solder body falls or rolls along the curved line such that the solder body is properly transported from the drop entry to the drop exit/the common exit opening and, thus, to the application nozzle.

According to an aspect of the invention a cross-section of the drop duct may narrow from the top to the bottom of the application device. As a result, the solder body may be easily dropped into the drop entry by the conveying device and is properly transported to the drop exit/the common exit opening.

According to an aspect of the invention the apparatus may further comprise a housing formed of an upper housing part and a lower housing part. The application device with the laser duct and the drop duct may be integrated in the lower housing part and the conveying device may be placed between the upper housing part and the lower housing part. Further, the upper housing part and the lower housing part may be distanced by a spacer which encloses the conveying device. This modular configuration of the housing allows a fast replacement of the conveying device and/or the lower housing part such that the apparatus according to the present invention may be easily adapted to solder bodies comprising another, e.g., a larger, diameter.

Further, the upper housing part may form a guide duct configured to guide solder bodies to the conveying device. It is to be noted that the guide duct and the drop exit of the drop duct are preferably distanced from each other to avoid multiple solder bodies from falling into the drop duct and the conveying device thus needs to separately transport solder bodies from the guide duct to the drop exit. In particular, the guide duct and the drop duct can be rotationally displaced to each other and the conveying device may convey the solder bodies by using a transport element which is rotatable, e.g., a rotational disk. As mentioned above the conveying device, i.e., the transport element, is enclosed by the spacer and moves, i.e., rotates within the spacer. As a result, the solder bodies can be properly introduced into the conveying device via the guide duct.

According to another aspect of the invention the guide duct may extend along a straight line through the upper housing part. Hence, the solder bodies may be transported to the conveying device without getting stuck.

According to an additional aspect of the invention the guide duct may be formed as an aspherical space, i.e., as a space that is not spherical and not cylindrical and comprises a tapering cross-section through the upper housing part. The guide duct is formed so as to swirl up the solder bodies present in the guide duct. In particular, the aspherical space is slightly funnel shaped. In addition, the aspherical space may taper against a movement direction of the conveying device, i.e., against a rotational movement direction of the transport element. Further, a radial outer wall portion of the guide duct may be formed tangential to a rotational movement direction of the transport element, i.e., the rotational disk. Moreover, a position of the radial outer wall portion is positioned outside an end of the transport element, i.e., outside a radius of the rotational disk. Hence, solder bodies present in the guide duct are also arranged on the spacer enclosing the transport element, i.e., the rotational disk, so that the solder bodies are even more swirled up. An radial inner wall portion of the guide duct can include an inclined wall portion which is inclined outwardly with respect the guide duct at the top of the upper housing part. Therefore, the aspherical space further reduces the risk of solder bodies getting stuck in the guide duct. It is to be noted that the housing and the guide duct according to the above aspects may be implemented independently from an apparatus having a laser duct and a drop duct which are interconnected. Applicant thus reserves the right to file one or more divisional applications directed towards a laser-assisted soldering apparatus comprising the housing and the guide duct according to one of the above aspects, i.e., without comprising the interconnected laser duct and drop duct.

According to an aspect of the invention the apparatus can include a solder body reservoir configured to store a plurality of solder bodies and to supply solder bodies to the conveying device. In particular, the solder bodies can be supplied to the conveying device via the guide duct. Hence, the apparatus may operate for a long time without the need to refill new solder bodies.

According to an additional aspect of the invention the solder body reservoir can include a solder body tank and a line connecting the solder body tank and the guide duct. Hence, the apparatus and the solder body tank may be placed in a distanced manner and the solder body tank may be refilled without stopping an operation of the laser-assisted soldering apparatus. This is especially beneficial for an apparatus operating with large solder bodies.

According to a preferred aspect of the invention the line may be flexible. Hence, the solder body tank and the solder-assisted soldering apparatus can be decoupled from each other in terms of vibration. This is beneficial for a solder body tank carrying a heavy load due to storing a large number of solder bodies, especially a large number of large solder bodies. It is to be noted that the solder body reservoir, i.e., the solder body tank and the line, according to the above aspects may be implemented independently from an apparatus having a laser duct and a drop duct which are interconnected. Applicant thus reserves the right to file one or more divisional applications directed towards a laser-assisted soldering apparatus comprising the solder body reservoir or the solder body tank according to one of the above aspects, i.e., without comprising the interconnected laser duct and drop duct.

According to an aspect of the present invention the apparatus may further comprise an application nozzle holder detachably mounted to the bottom of the application device and configured to exchangeably hold the application nozzle. As a result, the apparatus may be adapted to a desired application by simply changing the application nozzle holder. In particular, application nozzle holders with different lengths may be mounted. Therefore, it is not necessary to use long application nozzles made out of ceramic materials like SiN, SiC, Al₂O₃, WC etc. Such application nozzles are expensive since they require a large amount of raw material and a high manufacturing tolerance over a large range, and include a high risk of destruction during manufacturing or mounting. Alternatively or additionally, the cavity of the application nozzle holder may be adapted to the used solder bodies. The application nozzle holder preferably tapers towards an opening of the application nozzle. Hence, an exit at the bottom of the application device through which the solder body is transported to the application nozzle holder, e.g., the common exit opening, the drop exit or the laser exit, can be designed large enough to apply large solder bodies and the apparatus can be adapted to smaller solder bodies by installing an application nozzle holder providing sufficient taper towards the application nozzle.

According to an additional aspect of the invention the application nozzle holder can include a collet chuck part configured to clamp the application nozzle. As a result, the application nozzle does not fall out when mounting it to the application nozzle holder.

According to a further aspect of the invention the application nozzle holder can include a cap nut configured to fasten the application nozzle to the application nozzle holder. As a result, the application nozzle holder securely holds the application nozzle. It is to be noted that the application nozzle holder according to the above aspects may be implemented independently from an apparatus having a laser duct and a drop duct which are interconnected. Applicant thus reserves the right to file one or more divisional applications directed towards a laser-assisted soldering apparatus comprising the application nozzle holder according to one of the above aspects, i.e., without comprising the interconnected laser duct and drop duct.

According to an aspect of the present invention the apparatus may further comprise a laser shield enclosing the application nozzle with a lateral play. Hence, the laser shield may shield a spot to be soldered by placing it around the spot such that it substantially comes into contact with the workpiece. Preferably, the spot to be soldered may be pre-heated by using a laser beam of the laser-assisted soldering apparatus, and the laser shield avoids scattering of the laser beam to other parts of the workpiece. Moreover, the pre-heating is limited to an area inside the laser shield.

According to an additional aspect of the present invention the laser shield may be detachably mounted to the housing, in particular the lower housing part, or the application nozzle holder. For this purpose, the application nozzle holder can include a holding unit configured to hold the laser shield. For example, a flange of the laser shield may be fixed to the application nozzle holder for example by screws. Hence, the laser shield may be easily installed to the application nozzle holder having the holding unit, such as screw holes.

According to a preferred aspect of the invention the laser shield can include a mounting part detachably mounted to the application nozzle holder or the bottom of the application device and a shielding part held at the mounting part so as to be movable with respect to the mounting part to any position between a retracted position in which a tip of the application nozzle is at a same level as a tip of the shielding part, and an ex-tended position where a tip of the application nozzle is fully enclosed within the shielding part. For example, the shielding part may be biased towards the extended position by means of an elastic element, such as a spring. Therefore, when the laser shield is approached towards and contacts the workpiece the shielding part is moved towards the retracted position. As a result, damage of the workpiece can be avoided while enabling an efficient shielding of the spot to be soldered.

According to a beneficial aspect of the present invention the laser shield can include a connection port configured to be connected to a vacuum source and/or an inert gas source. In addition, the connection port may be connected and switched between the vacuum source and the inert gas source such that one may be applied after the other. Hence, a vacuum atmosphere or an inert gas atmosphere may be formed inside the laser shield. As a result, the soldering process may be influenced positively. In particular, the inert gas present inside the shielding part may substitute the inert gas functioning as pressure gas and which is introduced when jetting the solder body out of the capillary so that less pressure gas needs to be introduced into the application nozzle. In particular, large solder bodies require less pressure gas for jetting them out of the application nozzle due to their larger weight. As a result, splattering of the liquefied or melted solder body can be avoided while positively influencing the soldering process. It is to be noted that the laser shield according to the above aspects may be implemented independently from an apparatus having a laser duct and a drop duct which are interconnected. Applicant thus reserves the right to file one or more divisional applications directed towards a laser-assisted soldering apparatus comprising the laser shield according to one of the above aspects, i.e., without comprising the interconnected laser duct and drop duct.

According to an aspect of the present invention the apparatus can include a laser coupling unit configured to couple a laser beam into the laser duct and comprising an optical window transparent for the laser beam. Hence, splattering of a laser source emitting the laser beam with solder material may be avoided. Furthermore, the laser source may be easily replaced or changed. It is to be noted that the laser coupling unit according to the above aspect may be implemented independently from an apparatus having a laser duct and a drop duct which are interconnected. Applicant thus reserves the right to file one or more divisional applications directed towards a laser-assisted soldering apparatus comprising the laser coupling unit according the above aspect, i.e., without comprising the interconnected laser duct and drop duct.

According to an aspect of the present invention the conveying device may be configured to transfer or transport a solder body from the guide duct to the drop entry. The conveying device can include a transport element with at least one receiving hole and the at least one receiving hole may be configured to receive a solder body to transport same from the guide duct to the drop entry along a predetermined movement path. An optical sensor may be provided along the movement path between the guide duct and the drop entry which is configured to detect a presence or an absence of a solder body inside the at least one receiving hole. Hence, it can be detected whether the receiving hole is loaded with a solder body by using the optical sensor.

According to an additional aspect of the present invention the apparatus may further comprise a control unit configured to control a movement of the conveying device, i.e., the transport element, and to adjust a movement pattern of the conveying device in case the optical sensor detects an absence of a solder body inside the at least one receiving hole. As a result, the movement pattern can be adjusted such that a receiving hole which is not loaded with a solder body is skipped such that the processing speed of the apparatus can be increased. It is to be noted that the conveying device and the control unit according to the above aspects may be implemented independently from an apparatus having a laser duct and a drop duct which are interconnected. Applicant thus reserves the right to file one or more divisional applications directed towards a laser-assisted soldering apparatus comprising the conveying device and the control unit according to one of the above aspects, i.e., without comprising the interconnected laser duct and drop duct.

According to an aspect of the present invention the apparatus can include a laser source configured to couple a laser beam into the laser duct, and a control unit configured to operate the laser source so as to emit the laser beam in a pulse modulated manner. As a result, the laser beam may be emitted so as to properly melt the solder body held in the application nozzle. The pulse modulation pattern needs to be adapted especially for large solder bodies in order to achieve a sufficient degree of melting or liquefaction.

According to a preferred aspect of the invention the control unit is configured to operate the laser source so as to emit a pre-pulse and to emit a main pulse after a delay time has elapsed after the pre-pulse has ended. Preferably, the pre-pulse includes a phase in which a power of the laser beam is gradually increased up to a set power value and a phase in which the laser beam with the set power value is constantly applied. By applying the pre-pulse with a gradually increasing power, the solder body is progressively heated and liquefied such that a dynamic of the liquid solder material is reduced compared to a case in which a pulse with a high constant power is applied immediately. As a result, large solder bodies can be properly melted or liquefied by using the apparatus. It is to be noted that the laser source and the control unit according to the above aspects may be implemented independently from an apparatus having a laser duct and a drop duct which are interconnected. Applicant thus reserves the right to file one or more divisional applications directed towards a control unit according to the above aspects and/or towards a laser-assisted soldering apparatus comprising the laser source and said control unit, i.e., without comprising the interconnected laser duct and drop duct.

According to an aspect of the present invention the apparatus can include a flux dispenser configured to dispense flux to a solder body exiting the application nozzle. In particular, the flux may be applied by means of a flux dispenser nozzle. The flux dispenser nozzle may be arranged inside the laser shield. Preferably, the flux is applied in a gaseous phase. This is achieved by introducing pressure gas via a pressure gas line connected to a flux tank storing liquid flux. As a result, flux may be easily applied to the solder body such that the soldering process may be influenced positively. It is to be noted that the flux dispenser according to the above aspect may be implemented independently from an apparatus having a laser duct and a drop duct which are interconnected. Applicant thus reserves the right to file one or more divisional applications directed towards a laser-assisted soldering apparatus comprising the flux dispenser according to the above aspect, i.e., without comprising the interconnected laser duct and drop duct.

As a result, the present invention provides a laser-assisted soldering apparatus that can be easily formed and can be easily adapted to different applications. Especially, the laser-assisted soldering apparatus may be easily adapted such that large solder bodies having a diameter in the range of 0.9 μm to 2 mm can be applied.

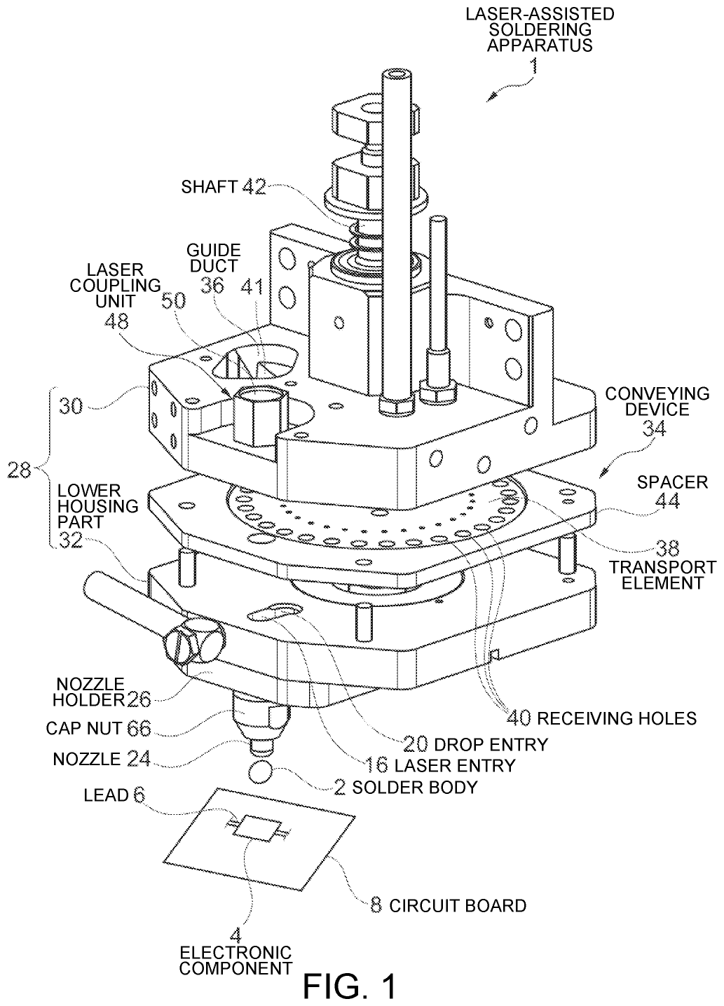

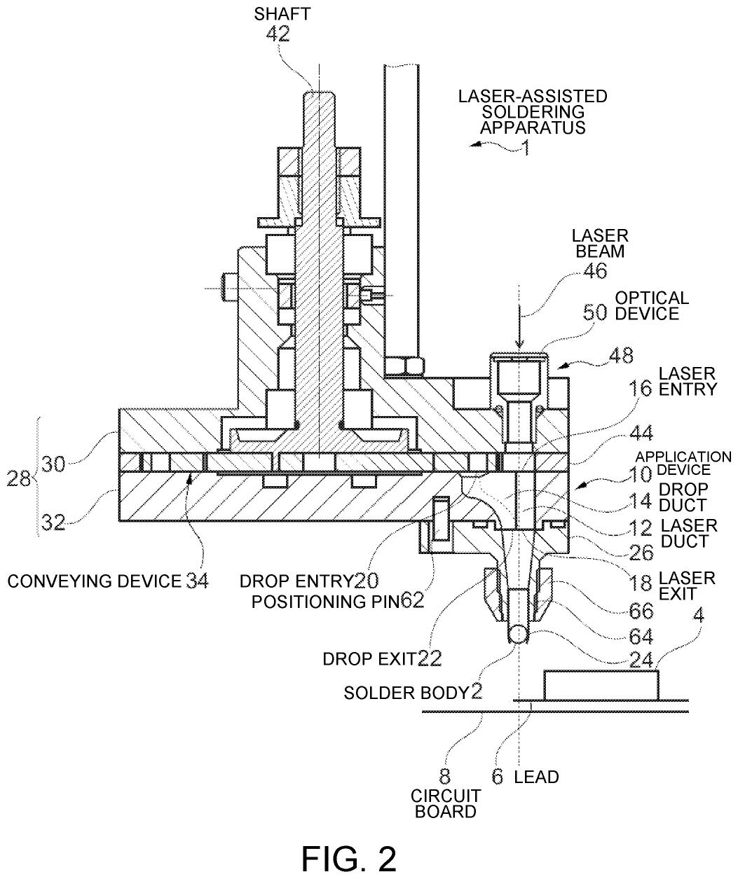

FIG. 1 shows an exploded view, and FIG. 2 shows a cross sectional view, of a laser-assisted soldering apparatus 1 (simply referred to as apparatus 1 in the following). The apparatus 1 is formed to separately apply a solder body 2 to a workpiece. In the present embodiment, the workpiece is formed by an electronic component 4 comprising at least one lead 6, which is to be soldered to a land (not shown) of a circuit board 8. The workpiece is not limited to this, and the apparatus may be used for other workpieces that require soldering.

As shown in FIG. 2, the apparatus 1 comprises an application device 10 having a laser duct 12 and a drop duct 14. The laser duct 12 extends along a straight line from a laser entry 16 at the top of the application device 10 to a laser exit 18 at the bottom of the application device 10. In particular, the laser duct 12 is formed cylindrically. The drop duct 14 extends from a drop entry 20 at the top of the application device 10 to a drop exit 22 at the bottom of the application device 10. In particular, the drop duct 14 extends along a curved line from the top to the bottom of the application device 10. Preferably, a cross-section of the drop duct 14 narrows from the top to the bottom of the application device 10.

As shown in FIG. 2, the laser duct 12 and the drop duct 14 are formed so as to be interconnected over their full lengths from the top to the bottom of the application device 10. Thus, the drop entry 20 and the laser entry 16 form a common non-circular entry opening, and the drop exit 22 and the laser exit 18 form a common circular exit opening. In other words, the laser duct 12 and the drop duct 14 are formed so that their cross-sections overlap each other along their extensions from the top to the bottom of the application device 10 to form the common non-circular entry opening at the top and the common circular exit opening at the bottom of the application device 10. It is to be noted that a degree of overlapping of the cross-sections of the laser duct 12 and the drop duct 14 increases from a partial overlap at the top to a full overlap at the bottom of the application device 10. Hence, the drop entry 20 and the laser entry 16 are arranged side by side so as to form a common entry opening, and the drop exit 22 and the laser exit 18 are spatially coincident so as to form a common exit opening smaller than the common entry opening.

An application nozzle 24 is provided at the bottom of the application device 10 and is configured to temporarily hold a solder body 2 exiting the application device 10, in particular the drop exit 22 (see FIG. 2). In particular, the application nozzle 22 is connected to the common circular exit opening formed by the drop exit 22 and the laser exit 18. Preferably, the application nozzle 24 is held by an application nozzle holder 26, which is mounted to the bottom of the application device 10. The application nozzle holder 26, thus, connects the common circular exit opening and the application nozzle 24. The application nozzle holder 26 will be described later in detail.

In the present embodiment, the solder body 2 is held by the application nozzle 24 such that the diameter of the opening at the tip of the application nozzle 24 is smaller than the diameter of the solder body 2. In order to eject the solder body 2 from the application nozzle 24, the pressure inside the application nozzle 24 is increased by introducing pressure gas from a pressure gas source (not show), and the solder body 2 is melted or liquefied by using a later described laser beam 46. When the solder body 2 is sufficiently melted or liquefied, the solder body 2 is jetted towards a spot to be soldered on the workpiece due to the pressure inside the application nozzle 24.

However, the present embodiment is not limited to this, and an opening of the application nozzle 24 may be substantially the same or slightly larger than the diameter of the solder body 2 so that the solder body 2 can exit the application nozzle 24. The solder body 2 can then be held at the tip of the application nozzle 24 in that the application nozzle 24 is distanced from the workpiece less than the diameter of the solder body 2. Hence, the solder body 2 is held between the application nozzle 24 and the work piece. Afterwards, the laser beam 46 is applied to the solder body 2 in order to melt or liquefy it such that a solder joint is obtained on the workpiece. Then the application nozzle 2 is moved away from the workpiece.

As shown in FIGS. 1 and 2, the apparatus 1 comprises a housing 28 formed of an upper housing part 30 and a lower housing part 32. The application device 10 with the laser duct 12 and the drop duct 14 is integrated in the lower housing part 32. A conveying device 34 configured to separately convey solder bodies 2 to the drop entry 20 is placed between the upper housing part 30 and the lower housing part 32.

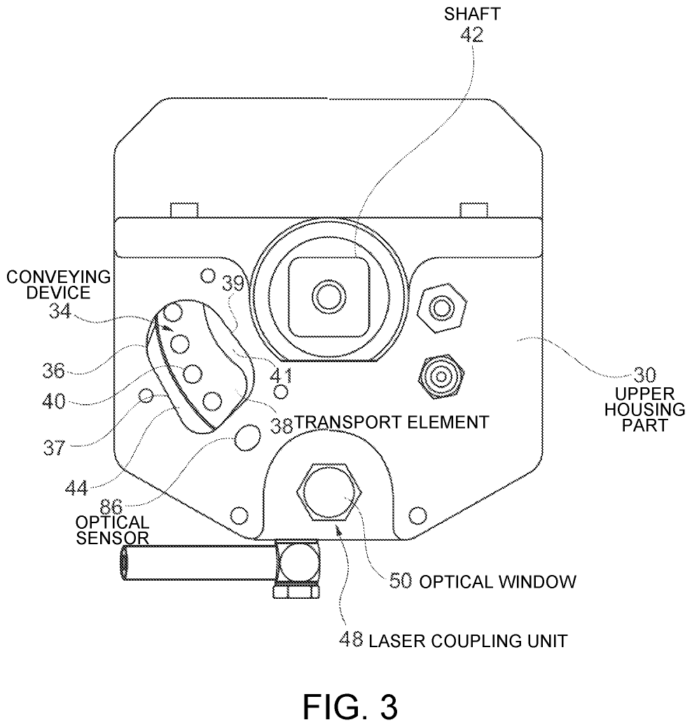

Further, as shown in FIGS. 1 and 3, the upper housing part 30 forms a guide duct 36 configured to guide solder bodies 2 to the conveying device 34. As shown in FIG. 2, the guide duct 36 extends along a straight line through the upper housing part 30.

As shown in FIG. 1, the guide duct 36 and the drop entry 20 are rotationally displaced such that multiple solder bodies 2 are avoided from falling into the drop duct 14. Hence, the conveying device 34 comprises a transport element 38, which in the present embodiment is formed as a rotational disk. The transport element 38 in this embodiment comprises equidistantly arranged receiving holes 40, which are configured to each receive a solder body 2 to transport it from the guide duct 36 to the drop entry 20 along a predetermined movement path, i.e., a rotational movement path. The transport element 38 in the present embodiment is turned in a counterclockwise direction (see FIG. 3) by means of a shaft 42 driven by an electric motor (not shown), which is operated by a controller (not shown) of the apparatus 1. Hence, the controller is configured to control the movement of the transport element 38 and, thus, the conveying device 34.

As shown in FIG. 1, the conveying device 34 can include a spacer 44 enclosing the transport element 38 in order to distance the upper housing part 30 and the lower housing part 32. Therefore, the housing 28 of the apparatus 1 can be easily dissembled. The conveying device 34 and the spacer 44, as well as the lower housing part 32, may be replaced according to a diameter of the solder bodies 2 to be used. As a result, the apparatus 1 may be flexibly adapted to different applications, i.e., solder bodies 2 with different diameters.

Further, as again shown in FIGS. 1 and 3, the guide duct 36 is formed as an aspherical space, i.e., as a space that is not spherical and not cylindrical and comprises a tapered cross-section through the upper housing part 30. The guide duct 36 is formed so as to swirl up the solder bodies 2 present in the guide duct 36. As shown in FIG. 1, the aspherical space is slightly funnel shaped. As shown in FIG. 3, the aspherical space tapers against a movement direction of the conveying device 34, i.e., the rotational movement direction of the transport element 38, i.e., the rotational disk. Further, an radial outer wall portion 37 of the guide duct 36 is formed tangentially to the rotational movement direction of the transport element 38. Moreover, the radial outer wall portion 37 is positioned outside the end of the transport element 38, i.e., outside the radius of the rotational disk. Hence, solder bodies 2 present in the guide duct 37 are also arranged on the spacer 44 that encloses the transport element 38 which is stationary, i.e., does not move, so that the solder bodies 2 are even more swirled up. An inner wall portion 39 of the guide duct 38 comprises an inclined wall portion 41 that is inclined outwardly with respect to the guide duct 36 at the top of the upper housing part 30. By being formed in this way, the guide duct 36 prevents multiple solder bodies 2 from getting stuck as they are transported to the conveying device 34.

As shown in FIG. 2, the apparatus 1 uses a laser beam 46 to liquefy the solder body 2 held in the application nozzle 24. The apparatus 1, thus, includes a laser coupling unit 48 configured to direct the laser beam 46 into the laser duct 12. The laser coupling unit 48 further includes an optical window 50 that is transparent to the laser beam 46. The apparatus 1 also includes a laser source (not shown) that can be detachably mounted to the laser coupling unit 48, for example by using a screw connection such that the laser beam 46 emitted by the laser source is coupled into the laser duct 12. The optical window 50 of the laser coupling unit 46 prevents splattering of the laser source with solder of a melted or liquefied solder body 2 being jetted towards the workpiece.

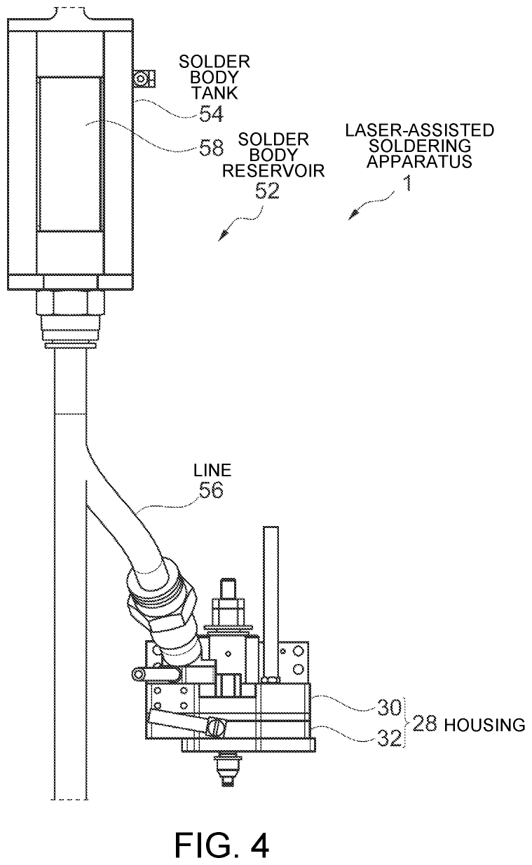

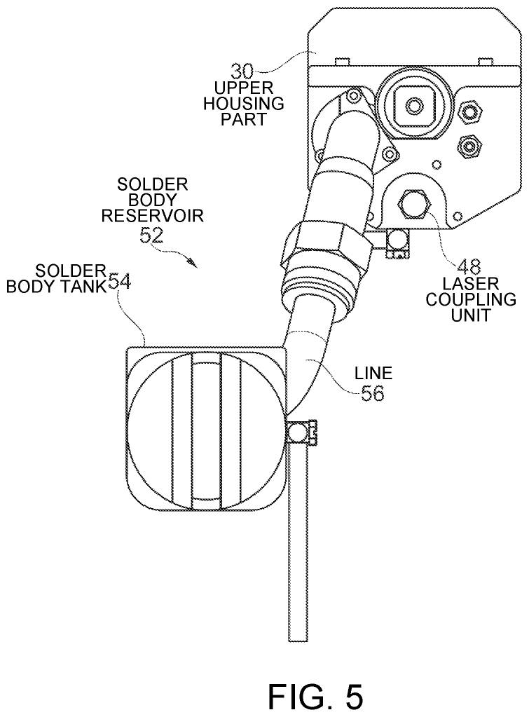

As shown in FIGS. 4 and 5, the apparatus 1 preferably comprises a solder body reservoir 52 configured to store a plurality of solder bodies 2 and to supply the solder bodies 2 to the conveying device 34 via the guide duct 36. The solder body reservoir 52 includes a solder body tank 54 and a line 56 connecting the solder body tank 54 and the guide duct 36. The solder body tank 54 is separated from the housing 28 of the apparatus 1. The line 56 is flexible such that a decoupling in terms of vibration of the solder body tank 54 and the apparatus 1 is achieved. Preferably, the solder body tank 54 includes a transparent window 58 that enables an easy monitoring of the fill level of the solder body tank 54. As a result, the solder body tank 54 may be monitored and refilled during the operation of the apparatus 1 without the need to stop the operation of the apparatus 1.

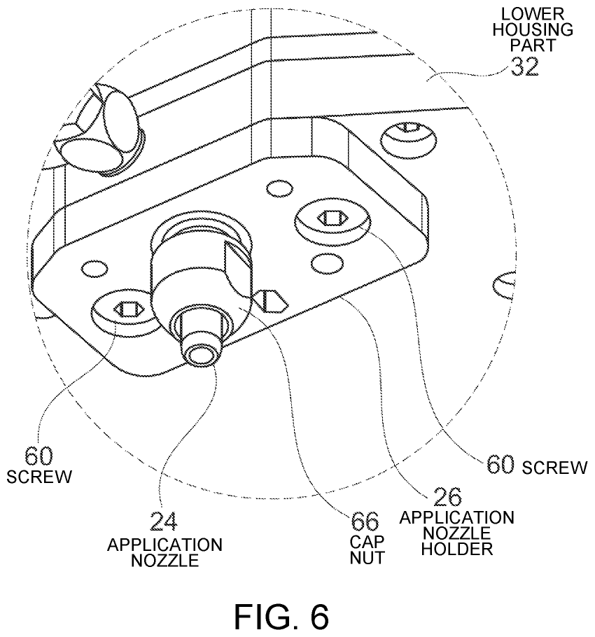

As mentioned above and shown in FIGS. 2 and 6, the apparatus 1 further includes an application nozzle holder 26 detachably mounted to the bottom of the application device 10, i.e., the lower housing part 32. In particular, the application nozzle holder 26 is attached to the lower housing part 32 by means of screws 60. In order to align the application nozzle holder 26 and the lower housing part 32, a positioning pin 62 can be engaged with the application nozzle holder 26 and the lower housing part 32. Therefore, the application nozzle holder 26 and the lower housing part 32 can be precisely arranged to each other so that no edges occur at a connection point of the application nozzle holder 28 with the lower housing part 32 that may negatively affect a solder body 2 falling or rolling down the drop duct 14.

The application nozzle holder 26 is configured to exchangeably hold the application nozzle 24. In the present embodiment, the application nozzle holder 26 comprises a collet chuck part 60 configured to clamp the application nozzle 24 such that it does not fall out during a mounting process. The application nozzle holder 26 also includes a cap nut 66 configured to fasten the application nozzle 24 to the application nozzle holder 26. As a result, the application nozzle 24 is securely held by the application nozzle holder 26 and can be precisely arranged towards an application direction.

As shown in FIG. 2, the common circular exit opening formed by the laser exit 18 and the drop exit 22 is significantly larger than the diameter of the application nozzle 24. The application nozzle holder 26 gradually tapers towards the application nozzle 24 without forming edges. Hence, the diameter of the common circular exit opening does not limit the usable size or diameter of the solder bodies 2. As a result, the apparatus 1 enables the utilization of large solder bodies 2. Furthermore, the apparatus 1 is also useable for smaller diameters by mounting an application nozzle holder 26 with sufficient taper. Therefore, the apparatus 1 can be flexibly adapted for the utilization of solder bodies 2 having different diameters.

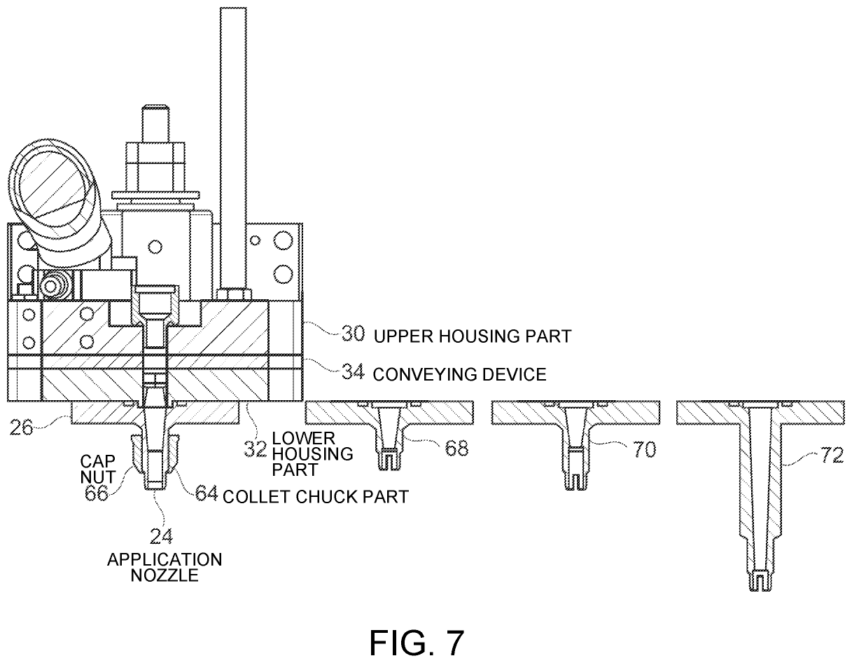

Examples of different application nozzle holders 26, 68 to 72 mountable to the lower housing part 32 are shown in FIG. 7. The length of the application nozzle holders 26, 68 to 72 can be easily adapted to a desired application without the need to stock multiple expensive application nozzles 24 having different lengths. Therefore, the utilization of different application nozzle holders 26, 68 to 72 makes it possible to avoid using application nozzles 24 that require a large amount of raw material and a tight manufacturing tolerance over a large range, and also include a high risk of destruction during manufacturing or mounting. Additionally or alternatively, the cavity, e.g., a taper angle, of the application nozzle holder 26 may be adapted to solder bodies 2 used for a desired application. Therefore, the apparatus 1 can be flexibly adapted to different applications.

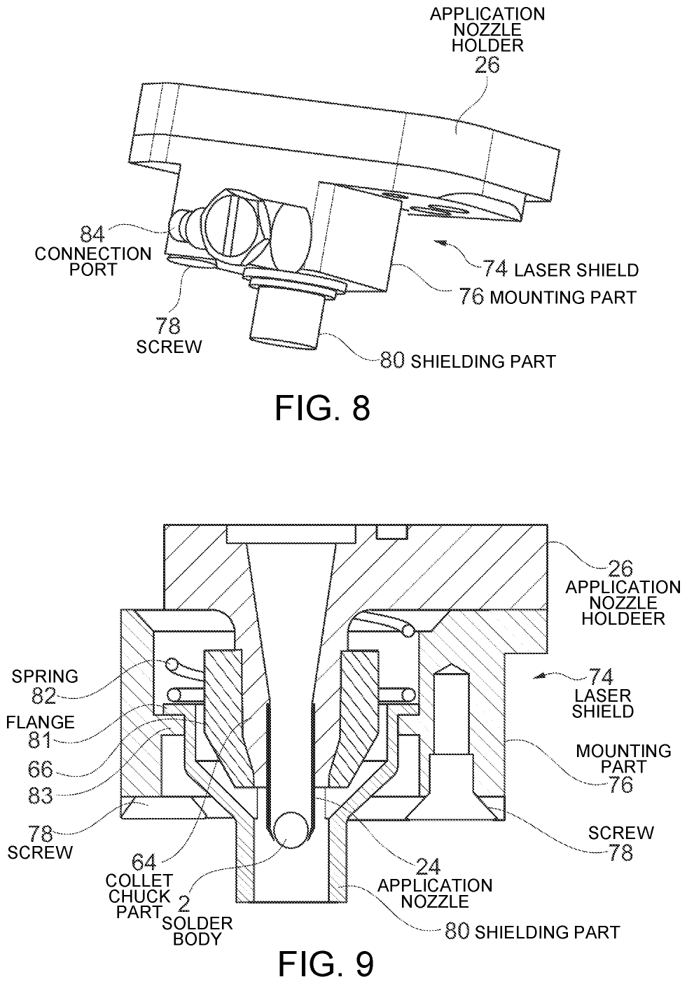

As shown in FIGS. 8 and 9, the apparatus 1 also includes a laser shield 74 enclosing the application nozzle 24 with a lateral play. Preferably, the laser shield 74 is detachably mounted to the application nozzle holder 26. For example, a flange of the laser shield 74 can be fixed to the application nozzle holder 26 by using screws. Alternatively, the laser shield 74 can include a mounting part 76 detachably mounted to the application nozzle holder 26, for example by means of screws 78 and a shielding part 80 held at the mounting part 76. It is to be noted that the laser beam 46 or a special pre-heating laser beam (not shown) can also be used to pre-heat a spot to be soldered on the workpiece, and the laser shield 74 effectively avoids scattering of the laser beam 46 arriving at the spot to be soldered. Further, a thermal expansion on the workpiece can be limited locally. Alternatively, the laser shield 74 or the mounting part 76 can be directly mounted to the lower housing part 32 or the bottom of the application device 10.

In particular, the shielding part 80 is held by the mounting part 76 so as to be movable with respect to the mounting part 76 to any position between a retracted position in which a tip of the application nozzle 24 is at a same level as a tip of the shielding part 80, and an extended position (see FIG. 9) where a tip of the application nozzle 24 is fully enclosed within the shielding part 80. For example, the shielding part 80 is biased towards the extended position by means of a spring 82. In particular, a flange 81 of the shielding part 80 is pushed by the spring 82 towards a protruding portion 83 of the mounting part 76 in order to fix the shielding part 80 in the extended position. Therefore, when the laser shield 80 is approached towards and contacts the workpiece, e.g., the circuit board 8 (see FIG. 1), the shielding part 80 is moved towards the retracted position. As a result, damage of the workpiece can be avoided while enabling an efficient shielding of the spot to be soldered.

The laser shield 74 can include a connection port 84 configured to be connected to a vacuum source or an inert gas source (not shown). As a result, particles inside the laser shield can be removed by vacuum suction. Further, an inert gas atmosphere can be created within the laser shield 74. Alternatively, the connection port 84 can be connected to and switched between the vacuum source and the inert gas source, and one may be applied after the other. For example, particles can be removed first, and then an inert gas atmosphere can be created. In this way, the soldering process can be influenced positively and the amount of inert gas which functions as pressure gas for jetting the solder body 2 out of the application nozzle 24 can be reduced.

As mentioned above, the conveying device 34 separately conveys solder bodies 2 from the guide duct 36 to the drop entry 20 of the drop duct 14 in order to supply the solder bodies 2 to the tip of the application nozzle 24. It can occur that a receiving hole 40 of the transport element 38 is not loaded with a solder body 2. The apparatus 1 thus comprises an optical sensor 86 provided along the movement path between the guide duct 36 and the drop entry 20 which is configured to detect a presence or an absence of a solder body 2 inside each receiving hole 40. For example, as shown in FIG. 3, the optical sensor 86 can be screwed to the upper housing part 30. The above-mentioned controller of the apparatus 1 is then configured to control a movement of the conveying device 34 and to adjust a movement pattern of the conveying device 34 in case the optical sensor 86 detects an absence of a solder body 2 inside one receiving hole 40. In the present embodiment in which the transport element 38 is a rotational disk having multiple receiving holes 40, the control unit skips a receiving hole 40 not loaded with a solder body 2 by turning the transport element 38 two positions instead of one. As a result, a processing speed of the apparatus 1 can be improved.

As mentioned above, the apparatus 1 includes a laser source (not shown) configured to couple the laser beam 46 into the laser duct 12 via the laser coupling unit 48 in order to melt or liquefy the solder body 2 held at the tip of the application nozzle 24. The control unit of the apparatus 1 is configured to operate the laser source so as to emit the laser beam 46 in a pulse modulated manner. This is especially necessary to properly melt or liquefy large solder bodies 2.

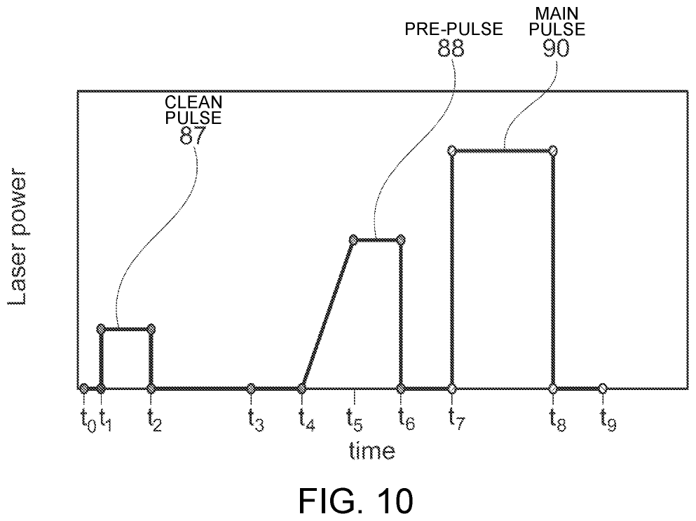

FIG. 10 shows a time diagram representing a laser pulse modulation pattern. During a first period between t0 and t1 (referred to as clean pulse delay) no laser beam 46 is applied. In the following period t1 to t2 (referred to as clean pulse period) a clean pulse 87 with a power in the range of 50 to 100 W, in particular 80 W, is applied without a solder body 2 being held in the application nozzle 24 in order to clean the spot to be soldered. Further, the clean pulse 87 can be applied during this period for pre-heating the spot to be soldered on the workpiece.

During a period between t2 and t3 which is about 100 ms (referred to as solder body load and detection time) no laser beam 46 is applied, and a solder body 46 is transported from the solder body reservoir 52 to the application nozzle 24. In addition, the proper loading of the application nozzle 24 is detected by using optical means or by detecting a pressure increase inside the application nozzle 24 when applying the pressure gas for ejecting the solder body 2.

Afterwards, between t3 and t4 (referred to as pre-pulse delay) no laser beam 46 is applied to the solder body 2 now present inside the application nozzle 24. Between t4 and t5 the laser beam 46 is applied to the solder body 2 held in the application nozzle 24 with a gradually increasing power. The slope of the power of the laser beam 46 is in the range of 0.5 W/ms and 1.5 W/ms, in particular 1 W/ms. At the time t5, the power of the laser beam 46 is then between 150 W and 250 W, in particular 200 W, and the laser beam 46 with this power is constantly applied until the time t6. The time between t4 and t6 is also referred to as pre-pulse period, and the pulse comprising the gradually increasing power and the constant power is referred to as pre-pulse 88. Alternatively, a pre-pulse 88 with only a constant power may also be applied. Nevertheless, the utilization of the pre-pulse 88 having the phase with the gradually increasing power gradually heats and melts the solder body 2 so that a dynamic of the melted solder is avoid. As a result, splattering of melted solder can be avoided.

Between t6 and t7 (referred to as mid-pulse delay) no laser beam 46 is applied to the solder body 2. During this period, the heat generated by the application of the pre-pulse 88 at an outer surface of the solder body 2 expands towards the inside of the solder body 2. As a result, a proper melting or liquefaction of the inside of the solder body 2 can be achieved.

Between t7 and t8 (referred to as main pulse period) a laser beam 46 with a power in the range of 300 W to 400 W, in particular 320 W or 350 W, is applied to the solder body 2 in order to sufficiently liquefy the same. This pulse is referred to as main pulse 90. Afterwards, during a time t8 and t9 (referred to as post-pulse delay) the solder body 2 is applied, in particular jetted, towards the workpiece as a result of an increased pressure inside the application nozzle 24 and the solder body 2 being sufficiently melted or liquefied. Afterwards, the apparatus 1 repeats the soldering process starting from t0.

By the above-described laser pulse modulation pattern, in particular by the pre-pulse 88 applied in the period between t4 and t6, the mid-pulse delay between t6 and t7 and the main pulse 90 applied between t7 and t8, the solder body 2 held in the application nozzle 24 is properly melted or liquefied. The pre-pulse 88, the mid-pulse delay and the main pulse 90 are especially necessary when applying large solder bodies 2 in order to guarantee a sufficient degree of liquefaction.

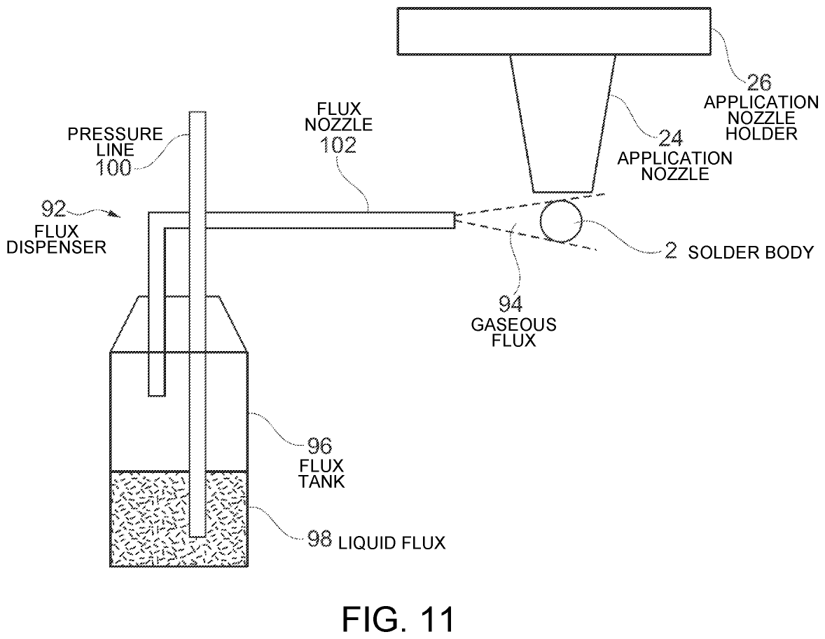

It is known that flux can positively influence a soldering process. However, flux usually needs to be applied to the spot to be soldered when using pre-formed solder bodies 2. The apparatus 1 according to the present embodiment comprises, as shown in FIG. 11, a flux dispenser 92 that applies flux 94 in a gaseous phase to a solder body 2 exiting the application nozzle 24. In this way, the cumbersome application of flux to the spot to be soldered can be avoided.

The flux dispenser 92 includes a flux tank 96 that stores flux 98 in a liquid phase. A pressure line 100 is connected to the flux tank 96 and creates overpressure so that the liquid flux 98 is output via a flux nozzle 102 as gaseous flux 94 to the solder body 2 exiting the application nozzle 24. As a result, the flux 94 adheres to the solder body 2 such that the soldering process is positively influenced. It is to be noted that a tip of the flux nozzle 102 can also be placed inside the laser shield 74. The application of the flux dispenser 92 is especially beneficial when using large solder bodies 2 because they provide a larger surface to which enough flux can adhere.

In summary, the laser-assisted soldering apparatus 1 according to the present invention can be configured and easily adapted to multiple applications. Especially, the apparatus 1 according to the present invention can be adapted for using large solder bodies 2 having a diameter in the range of 0.9 μm to 2 mm.

The present application discloses the following further embodiments 1 through 8:

### Embodiment 1

A laser-assisted soldering apparatus for the separate application of solder bodies, in particular solder balls, to a workpiece according to an embodiment 1 comprises an application device having a laser duct extending along a straight line from a laser entry at a top of the application device to a laser exit at a bottom of the application device, and a drop duct extending from a drop entry at the top of the application device to a drop exit at the bottom of the application device. The apparatus further comprises a conveying device configured to separately convey solder bodies to the drop entry, and an application nozzle provided at the bottom of the application device and configured to temporarily hold a solder body exiting the drop exit. The apparatus further comprises a housing formed of an upper housing part and a lower housing part.

The application device with the laser duct and the drop duct can be integrated into the lower housing part.

The conveying device can be placed between the upper housing part and the lower housing part.

The upper housing part and the lower housing part can be distanced by a spacer that encloses the conveying device.

The upper housing part can form a guide duct configured to guide solder bodies to the conveying device.

The guide duct and the drop exit of the drop duct can be spaced apart from each other.

The guide duct and the drop duct can be rotationally displaced to each other, and the conveying device can convey the solder bodies by using a transport element that is rotatable, e.g., a rotational disk.

The conveying device, i.e., the transport element, can be enclosed by the spacer and move, i.e., rotate, within the spacer.

The guide duct can extend along a straight line through the upper housing part.

The guide duct can be formed as an aspherical space, i.e., as a space that is not spherical and not cylindrical.

The guide duct can include a tapering cross-section through the upper housing part.

The aspherical space can be slightly funnel shaped.

The aspherical space may taper against a movement direction of the conveying device, i.e., against a rotational movement direction of the transport element.

A radial outer wall portion of the guide duct may be formed tangentially to a rotational movement direction of the transport element, i.e., the rotational disk.

A position of the radial outer wall portion is positioned outside an end of the transport element, i.e., outside a radius of the rotational disk so that solder bodies present in the guide duct are also arranged on the spacer enclosing the transport element, i.e., the rotational disk.

An radial inner wall portion of the guide duct can include an inclined wall portion that is inclined outwardly at the top of the upper housing part with respect to the guide duct.

### Embodiment 2

A laser-assisted soldering apparatus for the separate application of solder bodies, in particular solder balls, to a workpiece, according to an embodiment 2 includes an application device that has a laser duct extending along a straight line from a laser entry at the top of the application device to a laser exit at the bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus further includes a solder body reservoir configured to store a plurality of solder bodies and to supply solder bodies to the conveying device.

The solder body reservoir can include a solder body tank and a line connecting the solder body tank to the conveying device.

The line can be flexible such that the solder body tank and the solder-assisted soldering apparatus can be decoupled from each other in terms of vibration.

The solder body tank can include a transparent window.

### Embodiment 3

A laser-assisted soldering apparatus for the separate application of solder bodies, in particular solder balls, to a workpiece, according to an embodiment 3 includes an application device that has a laser duct extending along a straight line from a laser entry at a top of the application device to a laser exit at the bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus further comprises an application nozzle holder detachably mounted to the bottom of the application device and configured to exchangeably hold the application nozzle.

Application nozzle holders with different lengths can be mounted to the bottom of the application device.

A cavity of the application nozzle holder can be adapted to the used solder bodies.

The application nozzle holder can taper towards the application nozzle.

The application nozzle holder can include a collet chuck part configured to clamp the application nozzle.

The application nozzle holder can include a cap nut configured to fasten the application nozzle to the application nozzle holder.

### Embodiment 4

A laser-assisted soldering apparatus for the separate application of solder bodies, in particular solder balls, to a workpiece, according to an embodiment 4 includes an application device that has a laser duct extending along a straight line from a laser entry at the top of the application device to a laser exit at the bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus further includes a laser shield enclosing the application nozzle with a lateral play.

The apparatus may further include an application nozzle holder detachably mounted to the bottom of the application device and configured to exchangeably hold the application nozzle.

The laser shield can be detachably mounted to the bottom of the application device or the application nozzle holder.

The application nozzle holder or the application device can include a holding unit configured to hold the laser shield.

The laser shield can include a flange configured to be fixed to the application nozzle holder or the application device having the holding unit.

The holding unit can be screw holes, and the laser shield can be mounted by using screws.

The laser shield can include a mounting part detachably mounted to the application nozzle holder or the bottom of the application device, and a shielding part held at the mounting part so as to be movable with respect to the mounting part to any position between a retracted position in which the tip of the application nozzle is at the same level as the tip of the shielding part, and an extended position where the tip of the application nozzle is fully enclosed within the shielding part.

The shielding part may be biased towards the extended position by means of an elastic element, in particular a spring.

The laser shield can include a connection port configured to be connected to a vacuum source and/or an inert gas source.

The connection port can be connected and switched between the vacuum source and the inert gas source such that one may be applied after the other.

### Embodiment 5

A laser-assisted soldering apparatus for the separate application of solder bodies, in particular solder balls, to a workpiece, according to another embodiment includes an application device that has a laser duct extending along a straight line from a laser entry at the top of the application device to a laser exit at the bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus further includes a laser coupling unit configured to couple a laser beam into the laser duct and an optical window transparent for the laser beam.

A laser source configured to emit the laser beam may be exchangeably mounted to the laser coupling unit.

### Embodiment 6

A laser-assisted soldering apparatus for the separate application of solder bodies, in particular solder balls, to a workpiece, according to embodiment 6 includes an application device having a laser duct extending along a straight line from a laser entry at a top of the application device to a laser exit at a bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus further includes a housing formed of an upper housing part and a lower housing part. The application device with the laser duct and the drop duct are integrated in the lower housing part. The conveying device is placed between the upper housing part and the lower housing part. The upper housing part forms a guide duct configured to guide solder bodies to the conveying device. The guide duct and the drop exit of the drop duct are distanced from each other.

The guide duct and the drop duct can be rotationally displaced to each other.

The conveying device may be configured to transfer or transport a solder body from the guide duct to the drop entry.

The conveying device can include a transport element with at least one receiving hole and the at least one receiving hole may be configured to receive a solder body to transport same from the guide duct to the drop entry along a predetermined movement path.

The conveying device may convey the solder body by using a transport element which is rotatable, e.g., a rotational disk.

An optical sensor may be provided along the movement path between the guide duct and the drop entry which is configured to detect a presence or an absence of a solder body inside the at least one receiving hole.

The apparatus may further comprise a control unit configured to control a movement of the conveying device, i.e. the transport element, and to adjust a movement pattern of the conveying device in case the optical sensor detects an absence of a solder body inside the at least one receiving hole.

The transport element can include multiple receiving holes and the control unit may be configured to adjust the movement pattern such that a receiving hole which is determined to not be loaded with a solder body is skipped.

### Embodiment 7

A laser-assisted soldering apparatus for the separate application of solder bodies, in particular solder balls, to a workpiece, according to embodiment 7 includes an application device having a laser duct extending along a straight line from a laser entry at the top of the application device to a laser exit at the bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus includes a laser source configured to direct a laser beam into the laser duct, and a controller configured to operate the laser source so as to emit the laser beam in a pulse modulated manner.

The controller can be configured to operate the laser source so as to emit a pre-pulse and to emit a main pulse after a delay time has elapsed after the pre-pulse has ended.

The pre-pulse can include a phase in which a power of the laser beam is gradually increased up to a set power value and a phase in which the laser beam with the set power value is constantly applied.

The main pulse can include a phase in which a laser beam with a constant power is applied.

The constant power of the laser beam of the main pulse may be higher than the power of the pre-pulse.

The controller can be configured to operate the laser source so as to emit a cleaning pulse in order to clean and/or to heat the spot to be soldered on the workpiece before the pre-pulse.

### Embodiment 8

A laser-assisted soldering apparatus for the separate application of solder bodies, in particular solder balls, to a workpiece, according to embodiment 8 includes an application device that has a laser duct extending along a straight line from a laser entry at a top of the application device to a laser exit at a bottom of the application device, and a drop duct extending from a drop entry at the top of the application device to a drop exit at the bottom of the application device. The apparatus further includes a conveying device configured to separately convey solder bodies to the drop entry, and an application nozzle provided at the bottom of the application device and configured to temporarily hold a solder body exiting the drop exit. The apparatus includes a flux dispenser configured to dispense flux to a solder body exiting the application nozzle.

The flux may be dispensed by means of a flux dispenser nozzle.

The apparatus can further include a laser shield that encloses the apparatus with a lateral play, and the flux dispenser nozzle may be arranged inside the laser shield.

The flux dispenser can include a flux tank storing flux in a liquid phase.

A pressure line can be connected to the flux tank and can be configured to create overpressure in the flux tank so that the liquid flux is output via the flux nozzle as gaseous flux.

Each of the above specified further embodiments 1 through 8 represents a separate basis for the claimed invention.

### REFERENCE NUMERALS

1 laser-assisted soldering apparatus
2 solder body
4 electronic component
6 lead
8 circuit board
10 application device
12 laser duct
14 drop duct
16 laser entry
18 laser exit
20 drop entry
22 drop exit
24 application nozzle
26 application nozzle holder
28 housing
30 upper housing part
32 lower housing part
34 conveying device
36 guide duct
37 radial outer wall portion
38 transport element
39 radial inner wall portion
40 receiving hole
41 inclined wall portion
42 shaft
44 spacer
46 laser beam
48 laser coupling unit
50 optical window
52 solder body reservoir
54 solder body tank
56 line
58 transparent window
60 screw
62 positioning pin
64 collet chuck part
66 cap nut
68 application nozzle holder
70 application nozzle holder
72 application nozzle holder
74 laser shield
76 mounting part
78 screw
80 shielding part
81 flange
82 spring
83 protruding portion
84 connection port
86 optical sensor
87 clean pulse
88 pre-pulse
90 main pulse
92 flux dispenser
94 gaseous flux
96 flux tank
98 liquid flux
100 pressure line
102 flux nozzle

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

1-21. (canceled)

22. A laser-assisted soldering apparatus for separately applying solder bodies, the apparatus comprising:
an application device having a laser duct that extends along a straight line from a laser entry at a top of the application device to a laser exit at a bottom of the application device, and a drop duct that extends from a drop entry at the top of the application device to a drop exit at the bottom of the application device;
a conveying device that separately conveys the solder bodies to the drop entry; and
an application nozzle disposed at the bottom of the application device and adapted to temporarily hold a solder body received from the drop exit, wherein the laser duct and the drop duct are formed so as to be interconnected over their entire lengths from the top of the application device to the bottom of the application device, wherein the drop entry and the laser entry are arranged side by side so as to form a common entry opening, wherein the drop exit and the laser exit are spatially coincident so as to form a common exit opening that is smaller than the common entry opening, and wherein the application nozzle is connected to the common exit opening.

23. The apparatus of claim 22, wherein the common entry opening is non-circular, and wherein the common exit opening is circular.

24. The apparatus of claim 22, wherein the drop duct curves from the top of the application device to the bottom of the application device.

25. The apparatus of claim 22, wherein the drop duct has a cross-section that narrows from the top of the application device to the bottom of the application device.

26. The apparatus of claim 22, further comprising:
a housing that includes an upper housing part and a lower housing part, wherein the application device with the laser duct and the drop duct is integrated into the lower housing part, wherein the conveying device is disposed between the upper housing part and the lower housing part, and wherein a guide duct is formed in the upper housing part through which the solder bodies are guided to the conveying device.

27. The apparatus of claim 26, wherein the guide duct extends along the straight line through the upper housing part.

28. The apparatus of claim 26, wherein the guide duct has a tapered cross-section through the upper housing part.

29. The apparatus of claim 26, further comprising:
a solder body reservoir configured to store the solder bodies that are supplied to the conveying device

30. The apparatus of claim 29, wherein the solder body reservoir includes a solder body tank and a line, and wherein the line connects the solder body tank to the guide duct.

31. The apparatus of claim 22, further comprising:
an application nozzle holder detachably connected to the bottom of the application device, wherein the application nozzle holder holds the application nozzle.

32. The apparatus of claim 31, wherein the application nozzle holder includes a collet chuck part that clamps the application nozzle.

33. The apparatus of claim 32, wherein the application nozzle holder includes a cap nut that is configured to fasten the application nozzle to the application nozzle holder.

34. The apparatus of claim 31, further comprising:
a laser shield that encloses the application nozzle and surrounds a spot to be soldered.

35. The apparatus of claim 34, wherein the laser shield is detachably mounted to the application nozzle holder.

36. The apparatus of claim 35, wherein the laser shield includes a mounting part and a shielding part, wherein the mounting part is detachably connected to the application nozzle holder, and wherein the shielding part is extendable downwards so as to surround the application nozzle

37. The apparatus of claim 36, wherein the laser shield includes a connection port adapted to be connected to a vacuum source.

38. The apparatus of claim 22, further comprising:
a laser coupling unit that directs a laser beam into the laser duct, wherein the laser coupling unit has an optical window that is transparent to the laser beam.

39. The apparatus of claim 22, wherein the conveying device is adapted to transfer the solder bodies from the guide duct to the drop entry, and wherein the conveying device includes a transport element with receiving holes configured to receive the solder bodies and to transport the solder bodies from the guide duct to the drop entry.

40. The apparatus of claim 39, further comprising:
an optical sensor adapted to detect whether solder bodies are present in the receiving holes.

41. The apparatus of claim 40, further comprising:
a controller that adjusts a movement of the conveying device based on whether the optical sensor detects that no solder body is present in a receiving hole.

42. The apparatus of claim 22, further comprising:
a laser source that emits a laser beam that passes through the laser duct; and
a controller that controls the laser source to emit the laser beam in a pulse modulated manner.

43. The apparatus of claim 22, further comprising:
a flux dispenser that dispenses flux towards the solder body as the solder body exits the application nozzle.
